(19) United States
(12) Patent Application Publication
(10) Pub. No.: US 2024/0005692 A1
(43) Pub. Date: Jan. 4, 2024

(54) SENSING DEVICE, METHOD OF DRIVING SENSING DEVICE, AND DISPLAY DEVICE

(71) Applicant: WUHAN CHINA STAR OPTOELECTRONICS SEMICONDUCTOR DISPLAY TECHNOLOGY CO., LTD., Wuhan, Hubei (CN)

(72) Inventors: Pengfei Jiang, Wuhan, Hubei (CN); Mian Zeng, Wuhan, Hubei (CN); Liang Sun, Wuhan, Hubei (CN)

(73) Assignee: WUHAN CHINA STAR OPTOELECTRONICS SEMICONDUCTOR DISPLAY TECHNOLOGY CO., LTD., Wuhan, Hubei (CN)

(21) Appl. No.: 17/617,585

(22) PCT Filed: Nov. 23, 2021
(86) PCT No.: PCT/CN2021/132452

§ 371 Date: Dec. 9, 2021

(30) Foreign Application Priority Data
Oct. 9, 2021 (CN) 202111177890.X

(51) Int. Cl. G06V 40/13; G06V 10/147

(52) U.S. Cl. CPC G06V 40/1306; G06V 10/147; G06V 40/1318

(57) ABSTRACT

A sensing device, a display device and a driving method are provided. The sensing device includes a substrate and a plurality of sensing pixels disposed on the substrate in an array. Each of the plurality of sensing pixels comprising a signal-transmitting circuit and a signal-receiving circuit. A pixel group includes n of the plurality of sensing pixels, where n indicates the number of the signal-transmitting circuit in the pixel group and n is a positive integer greater than or equal to two. The sensing pixel in each of the pixel groups is electrically connected to the same signal-receiving circuit. In the present disclosure, a signal-receiving circuit is shared by each pixel group in the sensor so as to save the layout space of the signal-receiving circuit in the sensing device, simplify the circuit, reduce the number of signal-receiving circuits, and enhance the PPI of the sensing device.

### BACKGROUND

### 1. Field of the Disclosure

The present disclosure relates to the field of a sensor, and more particularly, to a sensing device, a driving method of the sensing device, and a display device.

### 2. Description of the Related Art

A sensing device has been widely utilized; for example, a sensing device for an ultrasonic type is adopted for fingerprint recognition. The ratio of signal-transmitting units to signal-receiving units disposed in a sensing device of the related art is one to one/1:1. A signal-transmitting unit corresponds to a signal-receiving unit. However, the circuit design of the ratio of a signal-transmitting unit to a corresponding signal-receiving unit defines the size of a sensing pixel unit, which makes it difficult to meet the requirement of high-resolution sensing pixels.

### SUMMARY

A sensing device, a driving method of the sensing device, and a display device are proposed by the embodiments of the present disclosure. An object of the present disclosure is to solve a problem that it is very hard to enhance the pixels per inch (PPI) of a sensing device.

According to an embodiment of the present disclosure, a sensing device includes a substrate and a plurality of sensing pixels disposed on the substrate in an array. Each of the plurality of sensing pixels comprising a signal-transmitting circuit and a signal-receiving circuit. A pixel group includes n of the plurality of sensing pixels, where n indicates the number of the signal-transmitting circuit in the pixel group and n is a positive integer greater than or equal to two. The sensing pixel in each of the pixel groups is electrically connected to the same signal-receiving circuit.

Optionally, a plurality of signal-transmitting circuits in each of the pixel groups are symmetrically distributed around the corresponding signal-receiving circuit.

Optionally, n/2 of the sensing pixels are arranged in a first direction and distributed over a side of the signal-receiving circuit in the pixel group. The other n/2 of the sensing pixels are arranged in the first direction and distributed over the other side of the signal-receiving circuit.

Optionally, n equals to four. The signal-receiving circuit is disposed between four of the signal-transmitting circuits.

Optionally, the sensing device further comprises a transducing unit layer. The transducing unit layer comprises a first transducing unit and a second transducing unit. The first transducing unit is connected to the signal-receiving circuit. The second transducing unit is connected to the signal-transmitting circuit. The first transducing unit is configured to convert a first electrical signal transmit by the signal-transmitting circuit into a first signal different from an electrical signal. The second transducing unit is configured to convert a received second signal different from an electrical signal into a second electrical signal and transmit the second electrical signal to the signal-receiving circuit. The first signal and the second signal are of the same type.

Optionally, the first transducing unit and the second transducing unit are the same transducing unit.

Optionally, the transducing unit layer is disposed on a side of the sensing pixel away from the substrate.

Optionally, the sensing device comprises an ultrasonic sensor, an optical sensor, or a piezoelectric sensor.

According to an embodiment of the present disclosure, a display device includes a display panel and a sensing device. The sensing device includes a substrate and a plurality of sensing pixels disposed on the substrate in an array. Each of the plurality of sensing pixels comprising a signal-transmitting circuit and a signal-receiving circuit. A pixel group includes n of the plurality of sensing pixels, where n indicates the number of the signal-transmitting circuit in the pixel group and n is a positive integer greater than or equal to two. The sensing pixel in each of the pixel groups is electrically connected to the same signal-receiving circuit.

Optionally, a plurality of signal-transmitting circuits in each of the pixel groups are symmetrically distributed around the corresponding signal-receiving circuit.

Optionally, n/2 of the sensing pixels are arranged in a first direction and distributed over a side of the signal-receiving circuit in the pixel group. The other n/2 of the sensing pixels are arranged in the first direction and distributed over the other side of the signal-receiving circuit.

Optionally, n equals to four. The signal-receiving circuit is disposed between four of the signal-transmitting circuits.

Optionally, the sensing device further comprises a transducing unit layer. The transducing unit layer comprises a first transducing unit and a second transducing unit. The first transducing unit is connected to the signal-receiving circuit. The second transducing unit is connected to the signal-transmitting circuit. The first transducing unit is configured to convert a first electrical signal transmit by the signal-transmitting circuit into a first signal different from an electrical signal. The second transducing unit is configured to convert a received second signal different from an electrical signal into a second electrical signal and transmit the second electrical signal to the signal-receiving circuit. The first signal and the second signal are of the same type.

Optionally, the first transducing unit and the second transducing unit are the same transducing unit.

Optionally, the transducing unit layer is disposed on a side of the sensing pixel away from the substrate.

Optionally, the sensing device comprises an ultrasonic sensor, an optical sensor, or a piezoelectric sensor.

According to an embodiment of the present disclosure, a driving method of a sensing device is provided. The sensing device comprising a substrate and a plurality of sensing pixels disposed on the substrate in an array. Each of the plurality of sensing pixels comprises a signal-transmitting circuit and a signal-receiving circuit. A pixel group includes n of the plurality of sensing pixels, where n indicates the number of the signal-transmitting circuit in the pixel group, and n is a positive integer greater than or equal to two. The sensing pixel in each of the pixel groups is electrically connected to the same signal-receiving circuit. The sensing device further comprises a transducing unit layer. The transducing unit layer comprises a first transducing unit and a second transducing unit. The first transducing unit is connected to the signal-receiving circuit. The second transducing unit is connected to the signal-transmitting circuit. The first transducing unit is configured to convert a first electrical signal transmit by the signal-transmitting circuit into a first signal different from an electrical signal. The second transducing unit is configured to convert a received second signal different from an electrical signal into a second electrical signal and transmit the second electrical signal to the signal-receiving circuit. The first signal and the second signal are of the same type. A driving period of each pixel group comprises n sub-driving periods. An mth sensing pixel transmits and receives signals in an mth sub-driving period where m is a positive integer less than or equal to n. Each of the sub-driving periods comprises a signal-transmitting time period and a signal-receiving time period.

The driving method comprises: transmitting, by the signal-transmitting circuit of the mth sensing pixel in the pixel group, a first electrical signal over the signal-transmitting time period of the mth sub-driving period; and receiving, by the signal-receiving circuit in the pixel group, a second electrical signal over the signal-receiving time period of the mth sub-driving period.

Optionally, the signal-transmitting time period and the signal-receiving time period partially overlap.

Optionally, n equals to four. The pixel group comprises a first sensing pixel, a second sensing pixel, a third sensing pixel, and a fourth sensing pixel. The driving period of each of the pixel group comprises a first sub-driving period, a second sub-driving period, a third sub-driving period, and a fourth sub-driving period; the first sub-driving period corresponds to the first sensing pixel. The second sub-driving period corresponds to the second sensing pixel. The third sub-driving period corresponds to the third sensing pixel. The fourth sub-driving period corresponds to the fourth sensing pixel.

In the present disclosure, a signal-receiving circuit is shared by each pixel group in the sensor so as to save the layout space of the signal-receiving circuit in the sensing device, simplify the circuit, reduce the number of signal-receiving circuits, and enhance the PPI of the sensing device.

### BRIEF DESCRIPTION OF THE DRAWINGS

To describe the technical solutions in the embodiments of this application more clearly, the following briefly introduces the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a top view of a sensing device according to a first embodiment of the present disclosure.

FIG. 2 is a circuit diagram of the sensing device according to a second embodiment of the present disclosure.

FIG. 3 is a first sectional view of the sensing device according to a third embodiment of the present disclosure.

FIG. 4 is a second sectional view of the sensing device according to a fourth embodiment of the present disclosure.

FIG. 5 illustrating a schematic diagram of the display device according to a fourth embodiment of the present disclosure.

FIG. 6 is a first timing diagram of the driving method of the sensing device according to the sixth embodiment of the present disclosure.

FIG. 7 is a second timing diagram of the driving method of the sensing device according to a seventh embodiment of the present disclosure.

FIG. 8 is another top view of a sensing device according to a preferred embodiment of the present disclosure.

### DETAILED DESCRIPTION OF THE EMBODIMENTS

To help a person skilled in the art better understand the solutions of the present disclosure, the following clearly and completely describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present disclosure. All of the terminologies containing one or more technical or scientific terminologies have the same meanings that persons skilled in the art understand ordinarily unless they are not defined otherwise. For example, “upper” or “lower” of a first characteristic and a second characteristic may include a direct touch between the first and second characteristics. The first and second characteristics are not directly touched; instead, the first and second characteristics are touched via other characteristics between the first and second characteristics. Besides, the first characteristic arranged on/above/over the second characteristic implies that the first characteristic arranged right above/obliquely above or merely means that the level of the first characteristic is higher than the level of the second characteristic.

According to an embodiment of the present disclosure, a sensing device includes a substrate and a plurality of sensing pixels disposed on the substrate in an array. Each of the plurality of sensing pixels comprising a signal-transmitting circuit and a signal-receiving circuit. A pixel group includes n of the plurality of sensing pixels, where n indicates the number of the signal-transmitting circuit in the pixel group and n is a positive integer greater than or equal to two. The sensing pixel in each of the pixel groups is electrically connected to the same signal-receiving circuit.

The present disclosure proposes a sensing device, a driving method of the sensing device, and a display device. The embodiments are separately introduced in detail. It is notified that the order of the following embodiments does not imply that the inventor has a preferable order.

### Embodiment 1

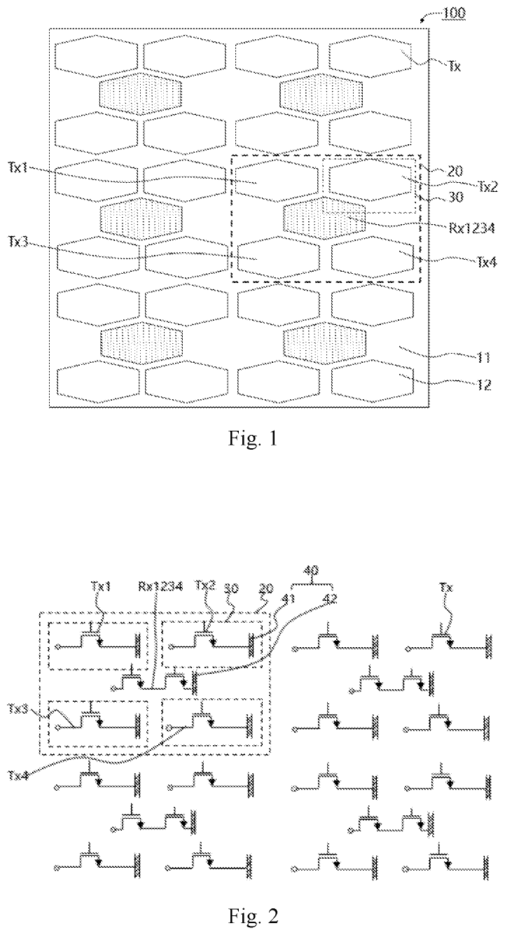

Please refer to FIG. 1 and FIG. 2. FIG. 1 is a top view of a sensing device 100 according to a first embodiment of the present disclosure. FIG. 2 is a circuit diagram of the sensing device 100 according to a first embodiment of the present disclosure.

The sensing device 100 includes a substrate 11 and a plurality of sensing pixels 30. The plurality of sensing pixels 30 are disposed on the substrate 11 in an array. Each of the plurality of sensing pixels 30 includes a signal-transmitting circuit Tx and a signal-receiving circuit Rx1234. N of the plurality of sensing pixels 30 form a pixel group 20. “N” indicates the number of signal-transmitting circuits Tx in the pixel group 20 and is a positive integer greater than or equal to two. The sensing pixel 30 in each of the pixel groups 20 is electrically connected to the same signal-receiving circuit Rx1234.

The sensing device 100 includes a substrate 11 and a sensing pixel layer 12. The sensing pixel layer 12 is disposed on the substrate 11. The plurality of sensing pixels 30 are disposed on the pixel group 20 in an array. Each of the plurality of sensing pixel 30 includes a signal-transmitting circuit Tx and corresponds to one of the signal-receiving circuits Rx1234. The sensing pixels 30 in the same pixel group 20 correspond to the same one of the signal-receiving circuits Rx1234.

N of the plurality of sensing pixels 30 form a pixel group 20. N indicates the number of signal-transmitting circuits Tx in the pixel group. Each of the plurality of sensing pixel 30 includes a signal-transmitting circuit Tx. Besides, each of the plurality of sensing pixel 30 includes or corresponds to one of the signal-receiving circuits Rx1234.

The signal-receiving circuit Rx1234 shared in the pixel group 20 is illustrated in each of the schematic diagrams as an example, which does not mean that only four transmitting circuits in pixel group 20 Tx are utilized. Practically, the number of the signal-transmitting circuits Tx shares one of the signal-receiving circuits Rx1234 in the pixel group 20 depends on the value of n. Specifically, the signal-transmitting circuit Tx is a circuit of the exciting signal and transmitting signal, and the signal-receiving circuits Rx1234 is a circuit of the returning signal and receiving signal. The signal-transmitting circuit Tx and the signal-receiving circuit Rx1234 may include a thin film transistor (TFT), a metal-oxide semiconductor field effect transistor (MOSFET), and so on. FIG. 2 illustrates that the signal-transmitting circuit Tx is formed by a TFT and that the signal-receiving circuit Rx1234 is formed by two TFTs as an example.

The substrate can be a glass substrate, a silicon-based substrate, which is defined in the present embodiment.

The sensing pixel 30 in each of the pixel groups 20 is electrically connected to the same signal-receiving circuit Rx1234 in the sensing device 100. In other words, each of the pixel groups 20 shares the signal-receiving circuit Rx1234 so as to save the layout space of the signal-receiving circuit Rx1234, simplify the circuit, and enhance the pixels per inch (PPI) of the sensing device 100.

The plurality of signal-transmitting circuits Tx in each of the pixel groups 20 are symmetrically distributed around the corresponding signal-receiving circuit Rx1234.

Because the plurality of signal-transmitting circuits Tx in each of the pixel groups 20 are symmetrically distributed around the corresponding signal-receiving circuit Rx1234, each of the signal-transmitting circuits Tx in the pixel group 20 receives the signal-receiving circuit Rx1234 through the shortest routing. Accordingly, the layout space of the signal-receiving circuit Rx1234 in the sensing device 100 is saved, the circuit is simplified, and the PPI (i.e., pixel density) of the sensing device 100 is enhanced.

N/2 of the sensing pixels 30 are arranged in a first direction and distributed over one side of the signal-receiving circuit Rx1234. The other n/2 of the sensing pixels 30 are arranged in the first direction and distributed over the other side of the signal-receiving circuit Rx1234.

N/2 of the sensing pixels 30 are arranged in the first direction and distributed over the one side of the signal-receiving circuit Rx1234, and the other n/2 of the sensing pixels 30 are arranged in the first direction and distributed over the other side of the signal-receiving circuit Rx1234 in one of the pixel groups 20. In other words, half of the sensing pixels 30 are arranged in the first direction and distributed over one side of the signal-receiving circuit Rx1234. The other half of the sensing pixels 30 are arranged in the first direction and distributed over the other side of the signal-receiving circuit Rx1234 in one of the pixel groups 20. For example, half of the number of sensing pixels 30 are arranged in a row or column direction and distributed over one side of the signal-receiving circuit Rx1234, and the other half of the sensing pixels 30 are arranged in a row or column direction and distributed over the other side of the signal-receiving circuit Rx1234 in one of the pixel groups 20. Owing to such a design, the arrangement of the sensing pixels 30 in the pixel group 20 is optimized, which benefits driving in a row or column sequence.

One of the signal-receiving circuits Rx1234 shared by each of the pixel groups 20 saves the layout space of the signal-receiving circuit Rx1234, simplify the circuit, reduce the number of signal-receiving circuits Rx1234, and enhance the PPI of the sensing device 100.

### Embodiment 2

A second embodiment of the present disclosure is the same as or similar to the first embodiment except “n=4”.

In some preferred embodiments, “n=4” means that a signal-receiving circuit Rx1234 is arranged between four signal-transmitting circuits Tx.

Please refer to FIG. 1 and FIG. 2. “N=4” means that a pixel group 20 includes four sensing pixels 30, and the four sensing pixels 30 share a signal-receiving circuit Rx1234. The shared signal-receiving circuit Rx1234 is disposed between four signal-transmitting circuits Tx.

Two of the signal-transmitting circuits Tx are arranged in a first direction and distributed over the one side of the signal-receiving circuit Rx1234, and the other two signal-transmitting circuits Tx are arranged in the first direction and distributed over the other side of the signal-receiving circuit Rx1234 in one of the pixel groups 20. The first direction may be either row or column direction. Owing to the design of the four sensing pixels 30 sharing the signal-receiving circuit Rx1234 in each of the pixel groups 20, the layout space of the signal-receiving circuit Rx1234 in a sensing device 100 is saved, the circuit is simplified, and the pixels per inch (PPI) of the sensing device 100 is enhanced.

### Embodiment 3

A third embodiment of the present disclosure is the same as or similar to the first and second embodiments except the structure or function of a sensing device 100.

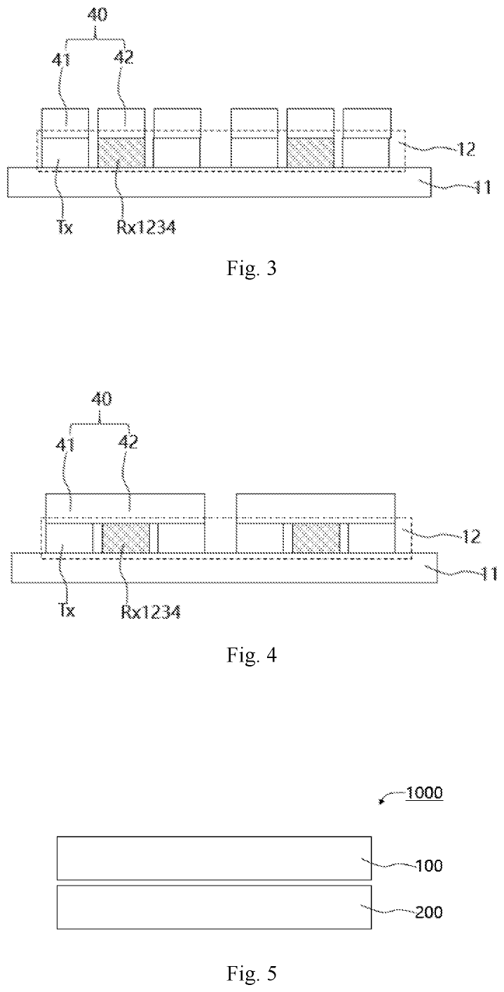

Please refer to FIG. 3 and FIG. 4. FIG. 3 is a first sectional view of the sensing device 100 according to the third embodiment of the present disclosure. FIG. 4 is a second sectional view of the sensing device 100 according to the present embodiment.

The sensing device 100 further includes a transducing unit layer 40. The transducing unit layer 40 includes a first transducing unit 42 and a second transducing unit 41. The first transducing unit 42 is connected to a signal-receiving circuit Rx1234. The second transducing unit 41 is connected to a signal-transmitting circuit Tx. The first transducing unit 42 is configured to convert a first electrical signal transmit by the signal-transmitting circuit Tx into a first signal different from an electrical signal. The second transducing unit 41 is configured to convert a received second signal different from an electrical signal into a second electrical signal and transmit the second electrical signal to the signal-receiving circuit Rx1234. The first signal and the second signal are of the same type.

Please refer to FIG. 3 illustrating the first transducing unit 42 and the second transducing unit 41 are different transducing units. The first transducing unit 42 and the second transducing unit 41 are independent and different transducing units.

The first transducing unit 42 and the second transducing unit 41 are the same transducing unit.

Please refer to FIG. 4 illustrating that the first transducing unit 42 and the second transducing unit 41 are the same transducing unit. Because the first transducing unit 42 and the second transducing unit 41 are the same transducing unit, the first transducing unit 42 and the second transducing unit 41 function at different time periods by multiplexing. For instance, the same transducing unit functions as the first transducing unit 42 does over a former period, and the same transducing unit functions as the second transducing unit 41 does over the latter period. In some preferred embodiments, a transducing unit layer 40 is disposed on one side of a sensing pixel 30 away from a substrate 11.

The signal-transmitting circuit Tx and the signal-receiving circuit Rx1234 are arranged on the substrate 11. Sequentially, the transducing unit 40 is disposed on one side of the signal-transmitting circuit Tx away from the substrate 11 and on one side of the signal-receiving circuit Rx1234 away from the substrate 11.

The sensing device 100 includes an ultrasonic sensor, an optical sensor, or a piezoelectric sensor.

If the sensing device 100 is an ultrasonic sensor, the first transducing unit 42 and the second transducing unit 41 correspond to the transducing unit of the ultrasonic sensor.

If the sensing device 100 is an optical sensor, the first transducing unit 42 and the second transducing unit 41 correspond to the transducing unit of the optical sensor.

If the sensing device 100 is a piezoelectric sensor, the first transducing unit 42 and the second transducing unit 41 correspond to a transducing unit of the piezoelectric sensor. Specifically, the first transducing unit 42 and the second transducing unit 41 are ultrasonic sensors, the first transducing unit 42 converts the first electrical signal transmit by the signal-transmitting circuit Tx into the first signal different from the electrical signal. The second transducing unit 41 converts the received second signal different from the electrical signal into the second electrical signal and transmits the second electrical signal to the signal-receiving circuit Rx1234. Meanwhile, both of the first signal and the second signal are ultrasonic signals. For example, the sensing device 100 is configured for fingerprint identification, the first signal is an ultrasonic signal transmitting to the surface of a finger, and the second signal is an ultrasonic signal which is reflected back by the finger.

If the first transducing unit 42 and the second transducing unit 41 are optical sensors, the first transducing unit 42 converts the first electrical signal transmit by the signal-transmitting circuit Tx into the first signal different from the electrical signal. The second transducing unit 41 converts the received second signal different from the electrical signal into the second electrical signal and transmits the second electrical signal to the signal-receiving circuit Rx1234. At this time, both of the first signal and the second signal are optical signals. For example, the sensing device 100 is configured for fingerprint identification, the first signal is an optical signal transmitting to the surface of a finger, and the second signal is an optical signal which is reflected back by the finger.

### Embodiment 4

A fourth embodiment of the present disclosure further proposes a display device 1000. The display device 1000 includes a sensing device 100 and a display panel 200 which is proposed by any one of the embodiments in the present disclosure as introduced above.

Please refer to FIG. 5 illustrating a schematic diagram of the display device 1000. The display device 1000 includes the sensing device 100 and the display panel 200. The sensing device 100 may be, but is not limited to, disposed on one side of the display panel 200.

The display panel 200 displays an image and the sensing device 100 performs fingerprint identification, so that that the display device 1000 can recognize partial or full fingerprints.

### Embodiment 5

A fifth embodiment of the present disclosure further proposes a driving method of a sensing device 100 which is proposed by the embodiments of the present disclosure.

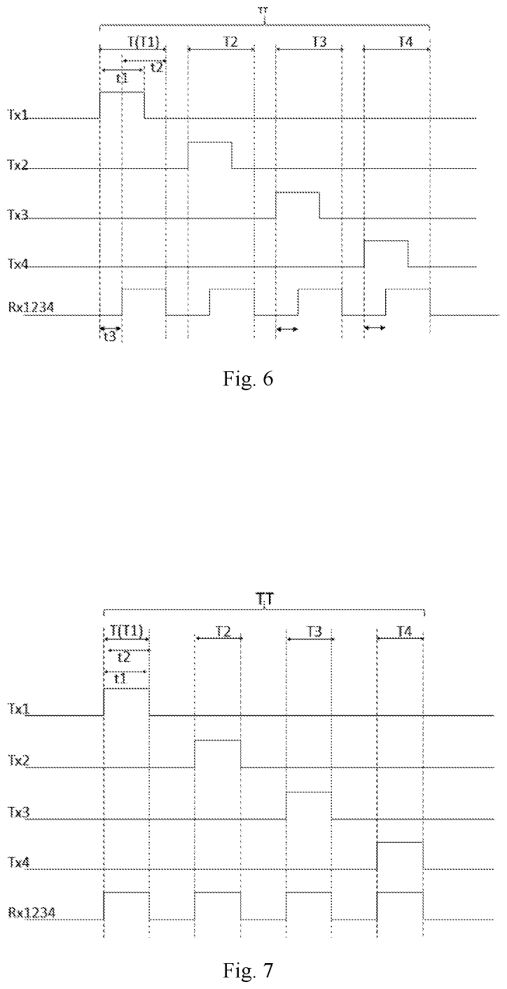

Please refer to FIG. 6 and FIG. 7. FIG. 6 is a first timing diagram of the driving method of the sensing device 100 according to the sixth embodiment of the present disclosure. FIG. 7 is a second timing diagram of the driving method of the sensing device 100 according to a seventh embodiment of the present disclosure.

As for the driving method of the sensing device 100, a driving period TT of each pixel group 20 includes n sub-driving periods T in the sensing device 100 which is introduced in any of the above-mentioned embodiments. In the mth sub-driving period T, the mth sensing pixel 30 transmits and receives signals. M is a positive integer less than or equal to n. Each of the sub-driving periods T includes a signal-transmitting time period t1 and a signal-receiving time period t2. Over the signal-transmitting time period t1 of the mth sub-driving period Tm, the signal-transmitting circuit Tx of the mth sensing pixel 30 in the pixel group 20 transmits a first electrical signal. Over the signal-receiving time period t2 of the mth sub-driving period Tm, a signal-receiving circuit Rx1234 in the pixel group 20 receives a second electrical signal.

The signal-transmitting time period t1 and the signal-receiving time period t2 partially overlap at least. FIG. 6 illustrates that the signal-transmitting time period t1 and the signal-receiving time period t2 at least partially overlap. It is suitable for the sensing device 100 that transmits the first electrical signal and receives the second electrical signal at a certain time lag, for example, the transmission of the first electrical signal and the reception at a time lag t3. The time lag t3 is a time lag that the first electrical signal and the second electrical signal propagate in the medium.

The signal-transmitting time period t1 and the signal-receiving time period t2 overlap at least. FIG. 7 illustrates that the signal-transmitting time period t1 and the signal-receiving time period t2 overlap overall. It is suitable for the sensing device 100 that transmits the first electrical signal and receives the second electrical signal at a certain time lag t3, which is far less than the signal-transmitting time period t1 and the signal-receiving time period t2. For instance, the first electrical signal and the second electrical signal propagate very rapidly, or the signal transmit time period t1 and the signal reception time period t2 are sufficient.

An n:1 signal transmits the signal-transmitting circuit Tx and receives the signal-receiving circuit Rx1234, and the reception and reading at intervals performs in the present embodiment of the disclosure. The circuit is simplified, and the pixels per inch (PPI) of the sensing device is enhanced. Besides, the signal is successfully read/transmit at high speed by means of the interval reception and reading without signal interference or signal crosstalk.

### Embodiment 6

A sixth embodiment of the present disclosure is the same as or similar to the fifth embodiment except “n=4”.

In some preferred embodiments, n equals to four (n=4). A pixel group 20 includes a first sensing pixel 31, a second sensing pixel 32, a third sensing pixel 33, and a fourth sensing pixel 34. The driving period of each of the pixel groups 20 includes a first sub-driving period T1, a second sub-driving period T2, a third sub-driving period T3, and a fourth sub-driving period T4. The first sub-driving period T1 corresponds to the first sensing pixel 31. The second sub-driving period T2 corresponds to the second sensing pixel 32. The third sub-driving period T3 corresponds to the third sensing pixel 33. The fourth sub-driving period T4 corresponds to the fourth sensing pixel 34.

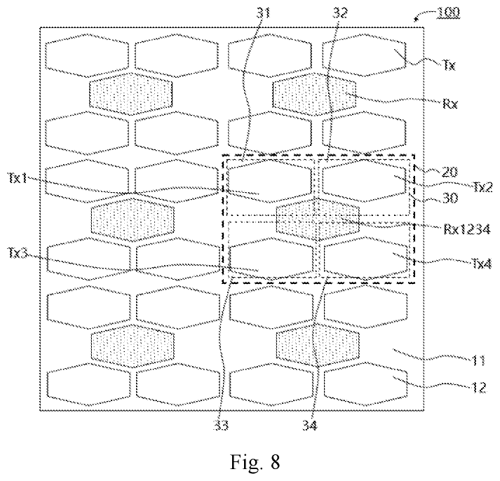

Please refer to FIG. 8. FIG. 8 is another top view of a sensing device 100 according to a preferred embodiment of the present disclosure. A first sensing pixel 31 includes a first signal-transmitting circuit Tx1 and a shared signal-receiving circuit Rx1234. A second sensing pixel 32 includes a second signal-transmitting circuit Tx2 and a shared signal-receiving circuit Rx1234. A third sensing pixel 33 includes a third signal-transmitting circuit Tx3 and a shared signal-receiving circuit Rx1234. A fourth sensing pixel 34 includes a fourth signal-transmitting circuit Tx4 and a shared signal-receiving circuit Rx1234.

A driving period TT of each of the pixel groups 20 includes four sub-driving periods T. In the mth sub-driving period T, the mth sensing pixel 30 transmits and receives signals. M is a positive integer less than or equal to n. M may be one, two, three, or four. Every one of the four sub-driving periods T includes a first sub-driving period T1, a second sub-driving period T2, a third sub-driving period T3, and a fourth sub-driving period T4. Every one of the first sub-driving period T1, the second sub-driving period T2, the third sub-driving period T3, and the fourth sub-driving period T4 includes a signal-transmitting time period t1 and a signal-receiving time period t2. Over the signal-transmitting time period t1 of the mth sub-driving period Tm, the signal-transmitting circuit Tx of the mth sensing pixel 30 in the pixel group 20 transmits a first electrical signal. Over the signal-receiving time period t2 of the mth sub-driving period Tm, a signal-receiving circuit Rx1234 in the pixel group 20 receives a second electrical signal.

The first signal-transmitting circuit Tx1 which the first sensing pixel 31 corresponds to transmits the first electrical signal over the signal-transmitting time period t1 of the first sub-driving period T1. The signal-receiving circuit Rx1234 in the pixel group 20 receives the second electrical signal over the signal-receiving time period t2 of the first sub-driving period T1.

The second signal-transmitting circuit Tx2 which the second sensing pixel 32 corresponds to transmits the first electrical signal over the signal-transmitting time period t1 of the second sub-driving period T2. The signal-receiving circuit Rx1234 in the pixel group receives the second electrical signal over the signal-receiving time period t2 of the second sub-driving period T2.

The third signal-transmitting circuit Tx3 which the third sensing pixel 33 corresponds to transmits the first electrical signal over the signal-transmitting time period t1 of the third sub-driving period T3. The signal-receiving circuit Rx1234 in the pixel group 20 receives the second electrical signal over the signal-receiving time period t2 of the third sub-driving period T3.

The fourth signal-transmitting circuit Tx4 which the fourth sensing pixel 34 corresponds to transmits the first electrical signal over the signal-transmitting time period t1 of the fourth sub-driving period T4. The signal-receiving circuit Rx1234 in the pixel group 20 receives the second electrical signal over the signal-receiving time period t2 of the fourth sub-driving period T4.

An 4:1 signal transmits the signal-transmitting circuit Tx and receives the signal-receiving circuit Rx1234, and the reception and reading at intervals performs in the present embodiment of the disclosure. The circuit is simplified, and the pixels per inch (PPI) of the sensing device is enhanced. Besides, the signal is successfully read/transmit at high speed by means of the interval reception and reading without cross-talk.

Above are embodiments of the present disclosure, which does not limit the scope of the present disclosure. Any modifications, equivalent replacements or improvements within the spirit and principles of the embodiment described above should be covered by the protected scope of the disclosure.

What is claimed is:

1. A sensing device, comprising a substrate and a plurality of sensing pixels disposed on the substrate in an array; each of the plurality of sensing pixels comprising a signal-transmitting circuit and a signal-receiving circuit;
n of the plurality of sensing pixels forming a pixel group; n indicating the number of the signal-transmitting circuit in the pixel group; n being a positive integer greater than or equal to two;
wherein the sensing pixel in each of the pixel groups is electrically connected to the same signal-receiving circuit.

2. The sensing device of claim 1, wherein a plurality of signal-transmitting circuits in each of the pixel groups are symmetrically distributed around the corresponding signal-receiving circuit.

3. The sensing device of claim 2, wherein n/2 of the sensing pixels are arranged in a first direction and distributed over a side of the signal-receiving circuit in the pixel group;
the other n/2 of the sensing pixels are arranged in the first direction and distributed over the other side of the signal-receiving circuit.

4. The sensing device of claim 3, wherein n equals to four; the signal-receiving circuit is disposed between four of the signal-transmitting circuits.

5. The sensing device of claim 1, further comprising a transducing unit layer;
the transducing unit layer comprises a first transducing unit and a second transducing unit; the first transducing unit is connected to the signal-receiving circuit; the second transducing unit is connected to the signal-transmitting circuit;
the first transducing unit is configured to convert a first electrical signal transmit by the signal-transmitting circuit into a first signal different from an electrical signal;
the second transducing unit is configured to convert a received second signal different from an electrical signal into a second electrical signal and transmit the second electrical signal to the signal-receiving circuit; the first signal and the second signal are of the same type.

6. The sensing device of claim 5, wherein the first transducing unit and the second transducing unit are the same transducing unit.

7. The sensing device of claim 5, wherein the transducing unit layer is disposed on a side of the sensing pixel away from the substrate.

8. The sensing device of claim 6, wherein the transducing unit layer is disposed on a side of the sensing pixel away from the substrate.

9. The sensing device of claim 5, wherein the sensing device comprises an ultrasonic sensor, an optical sensor, or a piezoelectric sensor.

10. A display device comprising:
a display panel; and
a sensing device, comprising a substrate and a plurality of sensing pixels disposed on the substrate in an array; each of the plurality of sensing pixels comprising a signal-transmitting circuit and a signal-receiving circuit;
n of the plurality of sensing pixels forming a pixel group; n indicating the number of the signal-transmitting circuit in the pixel group; n being a positive integer greater than or equal to two;
wherein the sensing pixel in each of the pixel groups is electrically connected to the same signal-receiving circuit.

11. The display device of claim 10, wherein a plurality of signal-transmitting circuits in each of the pixel groups are symmetrically distributed around the corresponding signal-receiving circuit.

12. The display device of claim 11, wherein n/2 of the sensing pixels are arranged in a first direction and distributed over a side of the signal-receiving circuit in the pixel group;
the other n/2 of the sensing pixels are arranged in the first direction and distributed over the other side of the signal-receiving circuit.

13. The display device of claim 12, wherein n equals to four; the signal-receiving circuit is disposed between four of the signal-transmitting circuits.

14. The display device of claim 10, wherein the sensing device further comprises a transducing unit layer;
the transducing unit layer comprises a first transducing unit and a second transducing unit; the first transducing unit is connected to the signal-receiving circuit; the second transducing unit is connected to the signal-transmitting circuit;
the first transducing unit is configured to convert a first electrical signal transmit by the signal-transmitting circuit into a first signal different from an electrical signal;
the second transducing unit is configured to convert a received second signal different from an electrical signal into a second electrical signal and transmit the second electrical signal to the signal-receiving circuit; the first signal and the second signal are of the same type.

15. The display device of claim 14, wherein the first transducing unit and the second transducing unit are the same transducing unit.

16. The display device of claim 14, wherein the transducing unit layer is disposed on a side of the sensing pixel away from the substrate.

17. The display device of claim 14, wherein the sensing device comprises an ultrasonic sensor, an optical sensor, or a piezoelectric sensor.

18. A driving method of a sensing device comprising a substrate and a plurality of sensing pixels disposed on the substrate in an array, wherein each of the plurality of sensing pixels comprises a signal-transmitting circuit and a signal-receiving circuit; n of the plurality of sensing pixels forms a pixel group; n indicates the number of the signal-transmitting circuit in the pixel group; n is a positive integer greater than or equal to two;
wherein the sensing pixel in each of the pixel groups is electrically connected to the same signal-receiving circuit;
wherein the sensing device further comprises a transducing unit layer; the transducing unit layer comprises a first transducing unit and a second transducing unit; the first transducing unit is connected to the signal-receiving circuit; the second transducing unit is connected to the signal-transmitting circuit; the first transducing unit is configured to convert a first electrical signal transmit by the signal-transmitting circuit into a first signal different from an electrical signal; the second transducing unit is configured to convert a received second signal different from an electrical signal into a second electrical signal and transmit the second electrical signal to the signal-receiving circuit; the first signal and the second signal are of the same type;
wherein a driving period of each pixel group comprises n sub-driving periods, an mth sensing pixel transmits and receives signals in an mth sub-driving period; m is a positive integer less than or equal to n; each of the sub-driving periods comprises a signal-transmitting time period and a signal-receiving time period;
wherein the driving method comprises:
transmitting, by the signal-transmitting circuit of the mth sensing pixel in the pixel group, a first electrical signal over the signal-transmitting time period of the mth sub-driving period; and
receiving, by the signal-receiving circuit in the pixel group, a second electrical signal over the signal-receiving time period of the mth sub-driving period.

19. The driving method of claim 18, wherein the signal-transmitting time period and the signal-receiving time period partially overlap.

20. The driving method of claim 18, wherein n equals to four; the pixel group comprises a first sensing pixel, a second sensing pixel, a third sensing pixel, and a fourth sensing pixel; the driving period of each of the pixel group comprises a first sub-driving period, a second sub-driving period, a third sub-driving period, and a fourth sub-driving period; the first sub-driving period corresponds to the first sensing pixel; the second sub-driving period corresponds to the second sensing pixel; the third sub-driving period corresponds to the third sensing pixel; the fourth sub-driving period corresponds to the fourth sensing pixel.
